(19) United States
(12) Patent Application Publication
(10) Pub. No.: US 2009/0013385 A1
(43) Pub. Date: Jan. 8, 2009

(54) Authorization System and Method

(75) Inventor: Dominika Olczak, Hagersten (SE)

Correspondence Address: VENABLE LLP, P.O. BOX 34385, WASHINGTON, DC, 20043-9998, US

(73) Assignee: INATOR KB, STOCKHOLM (SE)

(21) Appl. No.: 11/886,040

(22) PCT Filed: Mar. 7, 2006
(86) PCT No.: PCT/SE2006/000292

§ 371 Date: Jun. 24, 2008

(30) Foreign Application Priority Data
Mar. 8, 2005 (SE) 0500541-8

(51) Int. Cl. G06F 21/00

(52) U.S. Cl. 726/4

(57) ABSTRACT

An authorization system and a method for the protection of digital content and subscriber integrity in a digital content distribution system. At least one subscriber management system is arranged to maintain subscriber identification data. A subscriber authorization system arranged to maintain subscriber entitlement data separately from the subscriber identification data. The subscriber management system is arranged to identify a subscriber upon receipt of a request by the subscriber to extract digital content, and to generate an order to the subscriber authorization system to entitle the subscriber to access to the requested digital content. The subscriber authorization system is arranged to, upon receipt of such an order, verify the subscribers entitlement to access to the requested digital content and if verified transmit to a system client associated with the subscriber an entitlement to access the requested digital content.

### TECHNICAL FIELD

The present invention relates to an authorization system for the protection of digital content and subscriber integrity in a digital content distribution system in accordance with the preamble of claim 1.

The present invention also relates to a method for the protection of digital content and subscriber integrity in a digital content distribution system in accordance with the preamble of claim 10.

### BACKGROUND OF THE INVENTION

Authorization systems for the protection of digital content such as conditional access systems are well known and widely used in conjunction with currently available pay television systems. At present, such systems are usually based on the transmission of programmes scrambled with control words which are received by subscribers having a set-top box and a smart card for each subscription package.

The smart card for a subscription package from a particular service provider allows the scrambled programmes within the package to be descrambled and viewed. The broadcast stream further contains entitlement management messages and entitlement control messages, which are necessary for the smart card to descramble the broadcast.

In a conditional access application there are of course the requirements to protect the digital content in order to be able to draw revenues there from, but also a requirement to protect the personal integrity of the subscribers.

The number of other applications involving storage and distribution of digital content having stringent requirements for the protection of the digital content and the subscriber integrity is constantly increasing.

As an example of such another application the field of medical prescriptions and pharmacies may be studied. In many countries, such as e.g. Sweden, pharmacy companies are prohibited to maintain prescription information for a prolonged time period without a specific agreement by the customer, e.g. in Sweden presently no longer than two months. This makes it cumbersome for a pharmacy company using this information to maintain a single computerized system for handling prescriptions. Customers who do not agree and who have prescriptions which have an expiry date more than two months later will have to be removed from the system.

The currently available systems for the protection of digital content do not provide sufficient protection of personal integrity.

### SUMMARY OF THE INVENTION

One object of the invention is to provide an improved authorization system for the protection of digital content and subscriber integrity in a digital content distribution system and in particular an improved authorization system for the protection of digital content and subscriber integrity in a digital content distribution system comprising at least one subscriber management system arranged to maintain subscriber identification data, and a subscriber authorization system arranged to maintain subscriber entitlement data separately from the subscriber identification data.

This object is achieved by the system as claimed in claim 1.

Thanks to the provision of the subscriber management system being arranged to identify a subscriber upon receipt of a request by said subscriber to extract digital content, and to generate an order to the subscriber authorization system to entitle the sub-scriber to access to the requested digital content, and the subscriber authorization system being arranged to, upon receipt of such an order, verify the subscribers entitlement to access to the requested digital content and if verified transmit to a system client associated with the subscriber an entitlement to access the requested digital content, an authorization system providing a high level of protection for digital content whilst ensuring subscriber integrity is provided.

A further object of the invention is to provide an improved method for the protection of digital content and subscriber integrity in a digital content distribution system and in particular an improved method for the protection of digital content and subscriber integrity in a digital content distribution system comprising the steps of arranging at least one subscriber management system to maintain subscriber identification data; and arranging a subscriber authorization system to maintain subscriber entitlement data separately from the subscriber identification data.

This object is achieved by the method as claimed in claim 10.

Thanks to the provision of the further steps of arranging the subscriber management system to identify a subscriber upon receipt of a request by said subscriber to extract digital content, and generate an order to the subscriber authorization system to entitle the subscriber to access to the requested digital content, and arranging the sub-scriber authorization system to, upon receipt of such an order, verify the subscribers entitlement to access to the requested digital content and if verified transmit to a system client associated with the subscriber an entitlement to access the requested digital content, an method for the protection of digital content and subscriber integrity in a digital content distribution system providing a high level of protection for digital content whilst ensuring subscriber integrity is provided.

Preferred embodiments are listed in the dependent claims.

### DESCRIPTION OF DRAWINGS

In the following, the invention will be described in greater detail by way of example only with reference to attached drawings, in which

FIG. 1 is a schematic illustration of a the creation of an order sheet,

FIG. 2 illustrates a schematic example of how an entitlement could look like,

FIG. 3 is a schematic illustration of the example that the original order sheet is a prescription for medicines,

FIG. 4 illustrates schematically how the prescription is fragmented in the system between the SAS and the SMS,

FIG. 5 exemplifies schematically that the service number may represent only a product number,

FIG. 6 further exemplifies schematically compulsory and optional information in the entitlement,

FIG. 7 illustrates schematically how the SMS keeps track of its own entitlement through the generated entitlement key,

FIG. 8 illustrates schematically an overview of the system interactions and the subsystem deployment domains.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF EMBODIMENTS

The authorization system or conditional access system (CAS) in accordance with the present invention is intended to be a system to facilitate to maintenance of a Digital Rights Management (e.g., protection and collection of revenues associated with sales of proprietary digital content), ensure secure storage and delivery of data and services, and a strong user integrity service within the system. The CAS is used to authorize subscribers to receive proprietary digital content according to their registered subscriptions and to ensure security and confidentiality for different existing and future services.

The CAS in accordance with the present invention provides a comprehensive platform and toolkit for the protection and secure delivery of proprietary digital content and services to authorized subscribers. This is done using well-established secure delivery techniques and methods, including cryptography, authorization and access control, as well as data transmission techniques over several different data communication infrastructures. These infrastructures include for example broadcasting, IP, different wireless, and mobile networks. The primary purpose of a CAS for broadcasting is to determine which individual receivers/set-top decoders (also called Integrated Receiver Decoders—IDR) should be able to deliver particular programme services, or individual programmes, to the viewers.

The CAS is to be an access control system that enables subscribers to view TV and video content and receive services to their end-devices that are fee based. The CAS system will include several sub-systems, like database servers, a Back-End system, as well as CAS client software for different end-devices. The system may also in the future authorize execution of external software in, for example, the end-devices.

In the case of broadcasting the system will also include a Head-end. This is a sub-system used to aid in the scrambling of broadcast transmissions (with the help of a scrambling system). The CAS will also include backup and logging sub-systems, entitlement generator modules, key generation modules, system communication modules (to handle smooth system network communication,) system surveillance modules (for system failure notifications), and system administration tools.

Since the CAS is intended to be able to be shared between content providers at the sending end, the system is divided into two separate functional elements: a Sub-scriber Management System (SMS) and a Subscriber Authorization System (SAS). The SAS being the system to authorize end-user to access specific content and the SMS to manage the end-user data, for example subscriptions, individual purchases of programmes or services, etc.

The SAS is dependent on the CAS management tools, the SMS, and must communicate with the system using a management APIs. Several SMS may manage the SAS creating a complex situation of one assistant (the SAS) to several managers (SMS's). To avoid conflict or security breaches over data in the SAS, the CAS has the general rule that every SMS may only manage its own produced data. This is especially important for security and redundancy reasons so that several SMS does not work on the same data at the same time, or that one SMS does not steal or manipulates data belonging to another SMS. A SMS may be located at the business client site while the SAS is usually in the possession of the operator. Two SMS's belonging to different businesses may share the same SAS.

Any external system used to enter specific and limited information, for example entering purchase orders are considered part of the SMS and should be connected to the SMS and not to the SAS directly. This limits the APIs between the SAS and the SMS and enhances the flexibility of the SMS. The external API must however have very limited functionalities and are strictly controlled by special security rules and very limited access controls to the SMS. Their primary purpose is to increase the service for the end-user and should not be seen as a complement to the SMS-SAS input flow, the main CAS data flow, rather complementing interface to the SMS. No external systems may be interconnected to the SAS directly.

Databases are maintained to manage end-user and end-device information as well as storing entitlements and system client data. Due to very high security and integrity requirements the subscriber management data and the subscriber entitlement data are separated both logically and physically. This will ensure a high degree of personal integrity for the end-user, but also ensure a high degree of security to protect the entitlements being manipulated easily, thereby ensuring that access control is restricted to those subscribers who are entitled receive the content but no others.

The CAS main sub-system is the so-called Back-end system, and it is the Sub-scriber Management System (SMS) and Subscriber Authorization System (SAS) combined. The SMS handles all subscriber data like subscriptions, account information, orders, etc., while the SAS generates entitlement, after the orders and specifications of the SMS, and transmits them to the end-devices.

The second most important CAS sub-system is the so-called Head-end system. This system has the purpose of handle access control for the broadcasting transmissions. This system is closely integrated with the broadcasting transmissions and may thereby differ slightly depending on the broadcasting technique (terrestrial, satellite, cable, or mobile). This system must thereby be highly integrated with a scrambling system that handles the lowest layer of encryption of a clear broadcasting stream. There are clear standards for broadcast transmissions that are to be considered, but the CAS in general are not standardized for security reasons. The standards that are to be considered in these cases are: DVB-T Collection of standards addressing terrestrial transmissions; DVB-S Collection of standards addressing satellite transmissions; DVB-C Collection of standards addressing cable transmissions; DVB-H Collection of standards addressing handheld devices.

A CAS client is software running in a so-called end-device, which may be any electronic device that has a network connection and a screen able to display digital media content. The screen may be built in (for example a laptop, a smart phone, PDA, handheld TV, or even a refrigerator) or may attach a screen via cable (for example a set-top box, or a stationary computer). The client is used to handle received entitlements and unscramble/decrypt transmissions and digital data.

The CAS clients are run on end-device-specific operating systems like a Linux distribution or Windows XP for set-top boxes and other computer-based end-devices. Handheld devices usually require the client to run on PPC, Palm OS, or Windows CE, and producer specific operating systems for mobile phone devices, for example Symbian OS.

The system architecture is based on an information separation model. The sub-scriber and the subscriber activity information are split up between the SMS and the SAS. The information in the SMS does not contain any information about entitlements (alternatively called rights), which may be seen as viewer pre-selected activities, but only information about the subscribers. Every subscriber in the SMS has a set of entitlement keys, E-keys, containing everything from null to several keys). These keys lead to the entitlements in the SAS, but do not give any clues about the nature of the entitlements (e.g., does not reveal anything about which entitlement is connected to which subscriptions, orders, or other relevant information).

The SAS on the other hand does not contain information about any subscribers. Instead, the SAS keeps track of the entitlements, as well as parts of the system client information to direct the entitlements to the right end-device. When a specific activity is to be extracted (for example, for billing purposes) the SMS gives the order of extraction of a specific entitlement key and at the same time transmits the subscriber content to the matching sub-system. The SAS extracts the entitlement according to the key and also transmits it to the matching sub-system. The information is assembled in the matching system and made human readable.

The entitlements are created in the SAS using order information sent by the SMS to the SAS and are time limited. The time limit is set when the entitlement is generated and may have a lifetime of just a few minutes (or even seconds) to one or several years. An entitlement is either generated by a specific end-user request, which is performed by the end-user when he/she places an order via the end-device, or by an automatic generation in a subscriber scenario, where a new entitlement may be regenerated when a subscription fee has been paid. Entitlements in the SAS are associated with system clients, or the parts of the system client, which are located in the SAS.

The entitlements are loosely associated with end-device physical identification to direct the entitlements toward the right end-device. The end-device identification is created according specific identification criteria associated with the end-device and any other identifiable points of reference creating this physical identity. The physical identity is a logical identity created when end-user registers the end-device with the CAS operator, with the help of the data already existing about this end-device in the SMS or the data entered when the end-user registers the end-device with the SMS. The SMS in turn orders the SAS to create a physical identity with available data entered with the end-user registration. The physical identity is however separated from the direct identity (for example a set-top box ID) which may be directly associated with a subscriber in the SMS. This physical identity ensures a clear logical separation between the SMS data and the SAS data, thereby ensuring system privacy for the subscribers.

By following the separation model the system does not only create integrity for system clients, but also creating security through fragmentation and distribution of information. This system design model also creates a system that ensures that information leakage between different SMS owners is impossible. By stripping the SAS of subscriber information the system creates the conditions for several SMSs to share one SAS. This system model also creates the condition to use the system for other purposes than CAS control in media delivery. The system may be applied for many of the cases when personal integrity is an issue, for example medical research systems, security system for banking, and receipt for pharmaceuticals.

When a subscriber orders a programme service or other service an order is created with an order ID and one or several Key IDs. The order represents the data registered in the SAS at a specific time. An order is owned by one subscriber and a subscriber may have several orders. The order is the end-users representation of the entitlements the user is in possession of and this representation is used to create the entitlements in the SAS.

The order ID is unique for every order and is always associated with one order sheet. The Key IDs associated with the order sheet will at some point in time expire. An expired key ID may no longer be used by the end-user but is not deleted. A key ID is time limited, and the time limit decides the lifetime of the entitlements.

The Subscriber system sheet is the SMS representation of the order and this representation is kept in the subscriber account. Entitlements are represented with E-keys embedded within the Subscriber system sheets and kept “secret” to the public (e.g., not displayed in the open via any general interfaces, including to the administration personnel working and administrating the system). A programme service or a general service may also be made up of several entitlement keys, and thereby embedding several E-keys for that particular service.

Every E-key represents an entitlement in the SAS and maps the expiration key: Key ID, which is the expiration time for the entire order. In some cases the programme services or other services also contains a usage limit (e.g., a key that is limited to the number of times it may be used), which is also mapped to the E-key. Usually a usagelimited key will be used for different PPV services for one-time PPV services or several PPV services, for example a season ticket for sporting events. The content in a Sub-scriber system sheet is dynamic and may change over time. When an E-key expires it is deleted from the sheet. The original Key ID, in the Order sheet, used to map the E-key is however never deleted but only marked as expired.

Every entitlement is identified by its E-key, which is a unique entitlement identity within the SAS. The entitlement is associated with an end-device represented in the form of the system client identity stored in the SAS.

Although the above has been generally described with respect to conditional access in broadcasting systems, as mentioned above other implementations are also envisaged.

As an example, there are many special requirements posed on a service concerning medical and pharmaceutical service implementations. This generally concerns very high end-user privacy requirements and places special requirements on the SMS, while the SAS solution is not fundamentally affected. In this case every medicine and dose (for example, Ipren 400 mg), should be mapped in the system as a service while a diagnose (for example ammonia, depression, etc.) should be mapped as a Viewing Identity.

A set-up scenario is needed to activate the software in the end-device and authenticate the end-device and the end-user. The scenario is also needed to receive keys and initial entitlements if the end-device has a CAS software implementation (for example when a subscriber has a service subscription without pay-TV).

To be able to identify end-devices and end-users easily and fast over time, and transparently to the end-user the system needs to identify and verify the end-user identity in advance. For this purpose, the system needs to create a logical connection to the end-devices. When a logical connection exist, the system may easily maintain the functionality of the end-device delivering services smoothly if the identity remains intact and the end-device receives entitlements from its SMS. The identification is performed in the set-up scenario while the verification of the end-devices should be done by the SAS “interrogating” the end-device from time to time.

Generally the CAS has knowledge about the physical hardware identity in advance. This is a must for end-devices delivering content via broadcast transmissions (e.g. terrestrial, satellite, cable, and transmissions for mobile devices).

In cases where the hardware's physical identity is not known and not intended for broadcast transmissions, the CAS software in the end-device as a unique known serial key, that is used to identify the software which in turn should scan the environment for physical hardware identification points (for example Bluetooth addresses) and other external known hardware (for example a known access point).

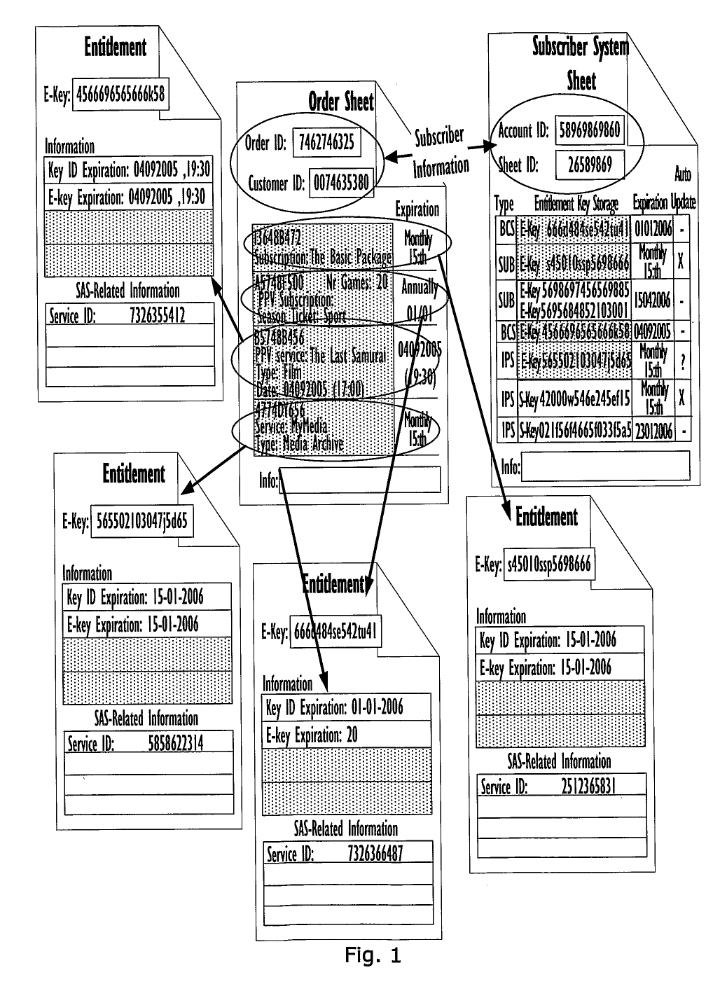

When a customer generates an order an Order sheet is created as illustrated in FIG. 1. The SMS receives the Order sheet and starts processing it. The personal sub-scriber information is stored in the subscriber account. An SAS order is created containing service label and a SAS customer ID (which is only a mapping table for the SAS to be able to recognize the system client). This ID may be used in plain text to recognize the system client or be used as an input to calculate a system client ID. This SAS order is temporary stored in the subscriber account, but also sent to the SAS.

When an SAS receives an SAS order to create entitlements it extracts the information and creates the entitlement according to the service packages existing and the recognized (via mapping or calculation) system client. The entitlements are thereby associated with the system client and stored. The E-keys identifying each entitlement are sent back together with the SAS order number.

When the SAS receives all the E-keys for the particular SAS order nr, the temporary stored SAS order in the subscriber account is discharged and replaced with the entitlement keys using a Subscriber System sheet.

In FIG. 1 the order is fragmented into four entitlements. The SMS have also chosen a low level of granularity since a new Subscriber system sheet has not been used, but instead the information has been added to an already existing Subscriber system sheet. The Subscribers personal information is kept in the SMS and an order is matched to a subscriber account, while the entitlements are kept in the SAS. Keys to the fragmented subscriber entitlement data are maintained by the subscriber management system SMS. The order to the subscriber authorization system to entitle the subscriber to access to the requested digital content contains the keys to the fragmented subscriber entitlement data.

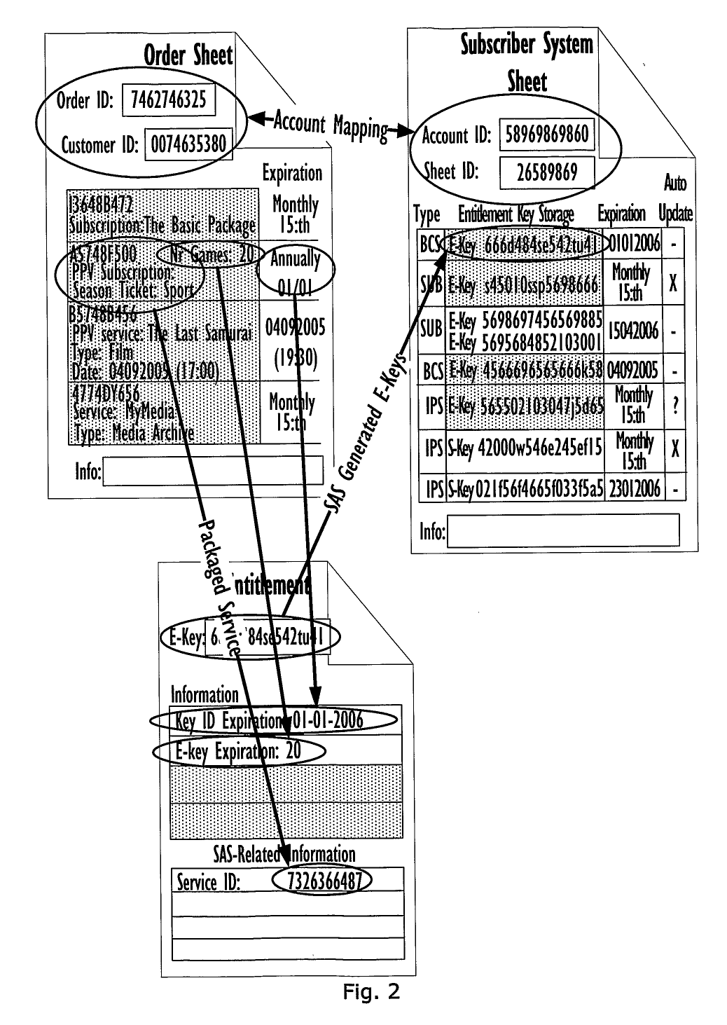

An example of how an entitlement could look like using the system framework is shown in FIG. 2.

A created entitlement may not have a specific transmission time. In these cases the entitlement is not placed in the transmission carousel. These entitlements are separately stored waiting for a transmission time. This transmission time is set via the end-user.

When the user places an order to the SMS the SMS orders an entitlement extraction order using the E-key. The system uses the E-key to find the entitlement places the entitlement in the entitlement carousel for immediate transmission. The SAS sends the SMS a success notification. Should the entitlement however not be in storage it is considered expired and a failure notification is sent to the SMS.

The purpose is to be able to offer services that are ordered and maybe paid for in advance. Such a service could for example be to purchase a season ticket for x number of sporting events of choice. Another possible service could be ordering medicine from a long time prescription where the different medicines are transformed to entitlements in the SAS, e.g. the subscriber entitlement data may be arranged to comprise medical prescription data whereby the personal subscription information comprises personal medical prescription information.

When an entitlement is expired it is cleaned up by the system and all traces of it disappear. For the system to be able to trace expired entitlements to expand a potential failure notification with an expired notice, the system may use an entitlement history functionality in order to keep track of expired entitlement for some predetermined limited amount of time. The system could then search the Entitlement History for expired entitlements before sending the failure notification to the SMS.

If the system is to keep personal privacy and information integrity through the whole CAS, the matching should be done through separate system functionality or a separate sub-system. This system should handle the matching and reconstruction of the original order.

When an end-user has a registered order (for example a season ticket for x number of sporting events) and needs to view the status of this order and history, the system needs to match the information. Since the SMS does not know how many entitlements the order has left, and the SAS does not know to whom the entitlement belongs, the matching system needs to step in and map the entitlements with the end-user.

The SMS places an information matching order, containing a matching order number for the associated E-keys, to the SAS and transmits the information the SMS possesses to the Matching module. When the SAS receives the matching order it transmits the information about the entitlements (e.g., expired, transmitted, unused, etc.) together with the received matching order number to the Matching module, where it is matched with the information from the SMS and interpreted according to specification found in the matching data, i.e. the matching module may be arranged to match the entitlement information to the corresponding metadata and subscriber identification data for enabling presentation to a system client associated with the subscriber of e.g. personal subscription information.

When an invoice is to be created the invoice-handling system needs information that is to be printed on the invoice. General information may be supplied by the SMS, but for detailed information the system needs to match the information from the SAS and the SMS. The matching functionality is also necessary to offer end-user services like purchase history and to be able to control entitlements not used.

For the matching functionality to be as flexile as possible, the functionality should be implemented as a module. The matching functionality could thereby be integrated in the SMS, the SAS, or a third matching system depending on the security requirements. Integration into the SMS is considered to be the less secure implementation and should generally be avoided.

For the Matching functionality to work correctly the Matching Module must be fed with matching instructions. These should be fed to the Matching module by the SMS when the information is disassembled when entitlements are created or when the sub-scriber identification data is to be matched with the entitlement information depending on system implementation.

Valid entitlements scheduled for transmission can be found in the queues, unscheduled entitlements can be found in the entitlement storage, and expired entitlements are stored in the Entitlement History.

Created entitlements must be possible to revoke as well distributed keys without putting too much burden on the system.

A key revocation should be handled a similar way as an order placement on a service. Every Subscriber System sheet has an embedded key for every available service in the subscribers account. In the same way as the SMS places an entitlement order, this time the system places an entitlement-revocation order. The SAS receives the revocation order, finds the entitlement associated with the e-key and expire the entitlement. A clean up process is commenced where any residues are removed from the entitlement carousels and associated queues.

To be able to quickly and easily revoke entitlements the system must have a straight forward method. A revocation may be initiated due to several reasons but is always initiated by the SMS owning the e-key(s).

A notice is to be sent back to the end-device after a successful revocation. Since the SAS does not know anything about the actual services the end-user notification of a revocation must be handled by the SMS.

An authorization system for the protection of digital content and subscriber integrity in a digital content distribution system in accordance with the present invention comprises at least one subscriber management system arranged to maintain subscriber identification data, and associated therewith a subscriber authorization system arranged to maintain subscriber entitlement data separately from the subscriber identification data. The subscriber management system SMS is arranged to identify a subscriber upon receipt of a request by the subscriber to extract digital content, and to generate an order to the subscriber authorization system SAS to entitle the subscriber to access to the requested digital content. The subscriber authorization system SAS is arranged to, upon receipt of such an order from the SMS, verify the subscribers entitlement to access to the requested digital content and if verified transmit to a system client, such as e.g. a settop-box, associated with the subscriber an entitlement to access the requested digital content. The keys may be used for this verification. As described in more detail in other parts of this document, the subscriber entitlement data may be maintained by the subscriber authorization system SAS in fragmented form.

In accordance with the present invention is also envisaged a method for the protection of digital content and subscriber integrity in a digital content distribution system. According to the method at least one subscriber management system is arranged to maintain subscriber identification data. A subscriber authorization system is arranged to maintain subscriber entitlement data separately from the subscriber identification data. In addition to the above steps, the in accordance with the inventive method the sub-scriber management system is arranged to identify a subscriber upon receipt of a request by said subscriber to extract digital content, and generate an order to the subscriber authorization system to entitle the subscriber to access to the requested digital content. The subscriber authorization system is further arranged to, upon receipt of such an order, verify the subscribers entitlement to access to the requested digital content and if verified transmit to a system client associated with the subscriber an entitlement to access the requested digital content.

The following implementation example illustrates how the system and the system solution may be applied for other purposes than the pure media driven market. In the following is introduced how entitlements together with the system solution may be used to manage prescription security with personal integrity. The solution is intended to be used in a pharmacy environment or similar.

In some countries, such as e.g. Sweden, it is forbidden for a company to keep prescription information more than a predetermined time period without customer specific agreement, e.g. for Sweden this time period is presently two months. This makes it difficult for a company using this information (usually pharmacies) to maintain one single system. Customers that don't agree and have prescriptions that have a lifetime longer than the predetermined time period must be removed from the system. By first making the prescription anonymous (with an entitlement) and later fragmenting the prescription into product specifications with a label, the information is no longer a prescription, but a fragment of information. This ensures that the legal issue is no longer an issue.

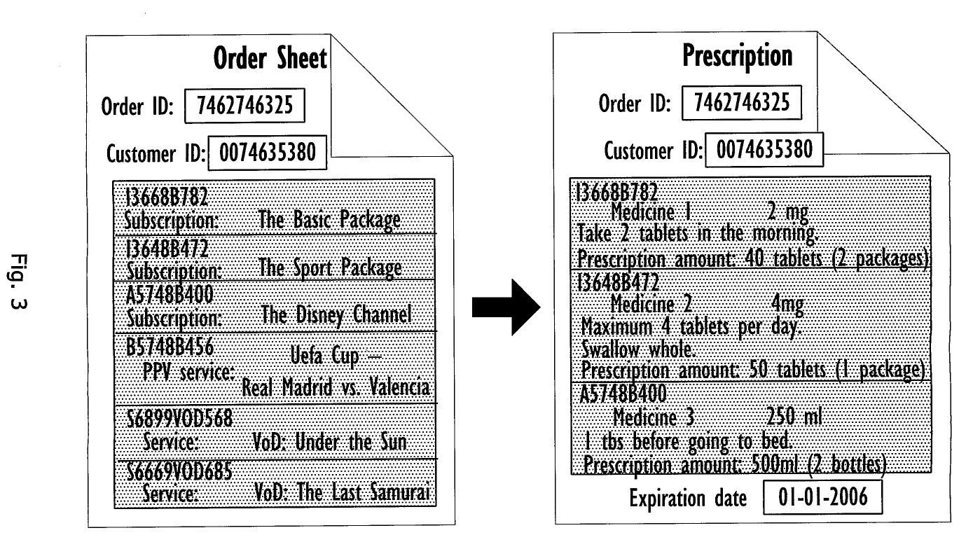

The system is based on the principle that the customer places orders to the SMS to extract information, but this task is instead done by the SAS. This is performed through a translation process where the extraction order is given by the customer to the SMS, and the SMS in turn gives the order further to the SAS, but in a format that it understands (via en E-key). The SMS functions as an translator (an Adaptor) and the order from the customer may come in any shape and size as long as the SMS translates it to a E-key and an Extraction-order number (to match the entitlement information to the right metadata and subscriber data in the Matching module). Metadata associated with the subscriber identification data may be maintained by the subscriber management system SMS. As illustrated in FIG. 3, the original order sheet may, for example, be a prescription for medicines. An Order sheet could for example be a subscription. FIG. 3 illustrates an example of a presumed prescription. In Sweden there are at most two medicine rows, but this may not be the case in other countries.

Prescriptions are fragmented according to the same general system rules as in all the solution's variations that may exist (for example media protection described above). The Prescription is firstly fragmented according to customer information and prescription data, e.g. making the prescription data anonymous. Thereafter, the prescription data is further fragmented into fragments matching a single service (e.g. a product, for example <product number>, <product name>, <product specification>, <producer>, <info>, etc). The service grouping is performed according to the viewing group principle. A viewing group should contain at least one film, channel, or other service (identified by a program, channel or a service IDs). Programs, films, channels, or other services could also be bundled together in different combinations and thereby creating viewing groups containing several programmes or service IDs (e.g., several identification attributes) in the so-called programme services or service packages. It should also be possible to bundle programme services and service packages in special viewing groups for combined service solutions. A product and any other service associated with this product are packaged into a so-called service group by the service packaging functionality.

Customer specific data is kept by the SMS, while the fragmented prescription data is kept in the SAS. Subscriber system sheets are used whenever granularity is to be added to the customers' accounts. The finest granularity level is a Subscriber system sheet per prescription. If Subscriber system sheets are used metadata about the prescription framework is generated and also kept if the SMS until an extraction order is received from a customer. The metadata is never kept in the SAS because the SAS will never need this information, and to maintain the SAS abstraction and reusability (e.g. component abstraction and reusability).

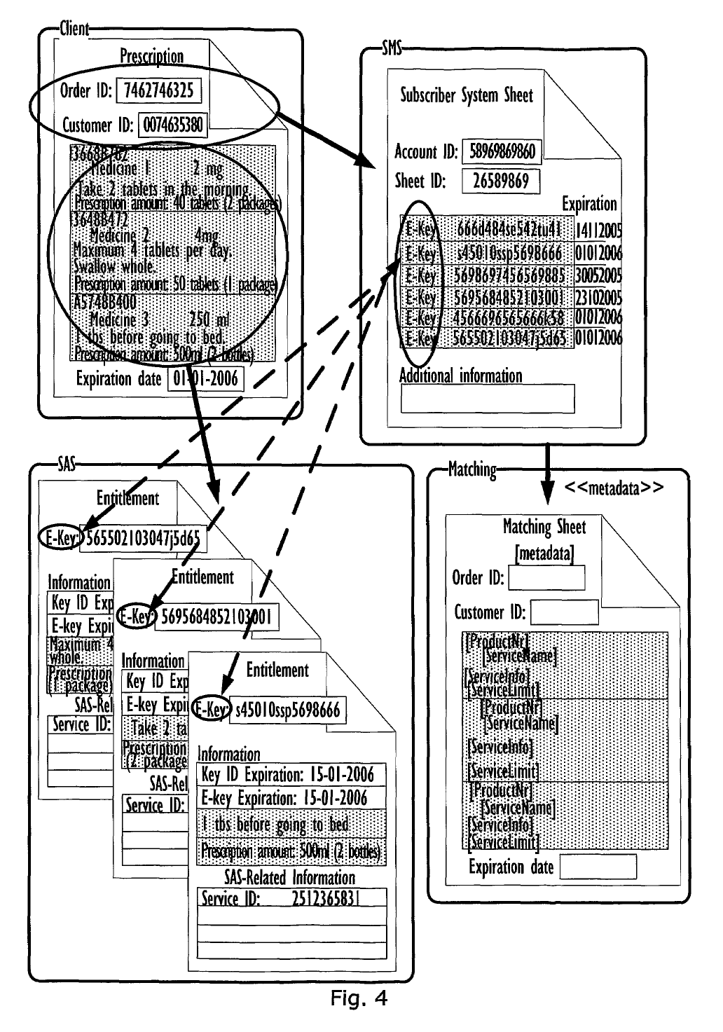

As illustrated in FIG. 4, the prescription is fragmented in the system between the SAS and the SMS according to the system model (shaded prescription data is sent to the SAS, while the customer data in the light areas remains in the SMS). The prescription frame (the metadata of the prescription “layout”) is sent to the Matching module at matching time.

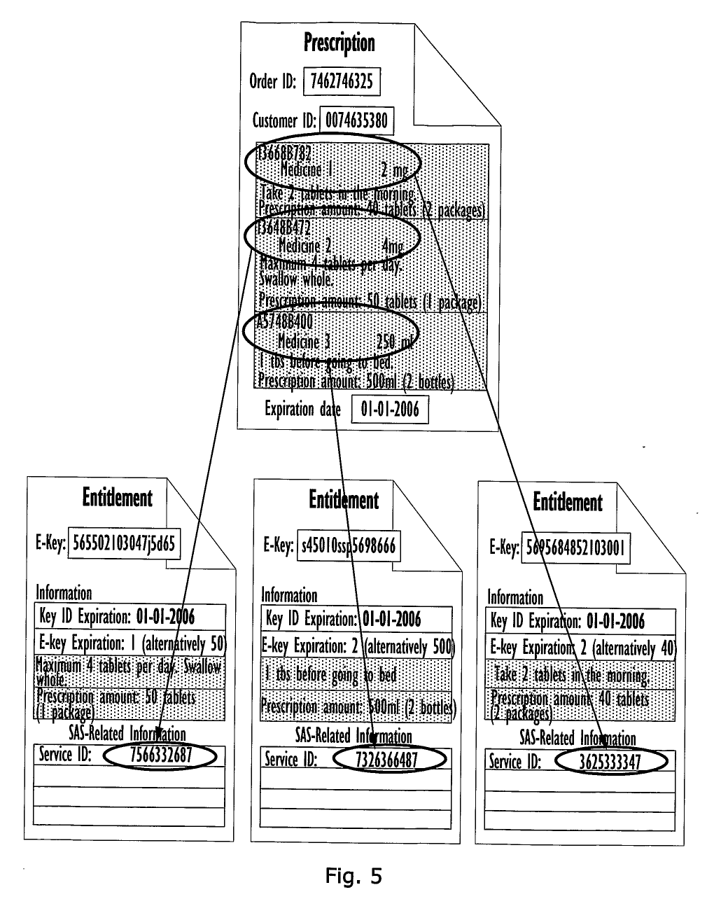

The service number in this solution, as illustrated in FIG. 5, may represent only product number, but may also be a service containing, for example, the product number and an instructional film how to use the product, important information about the product, etc.

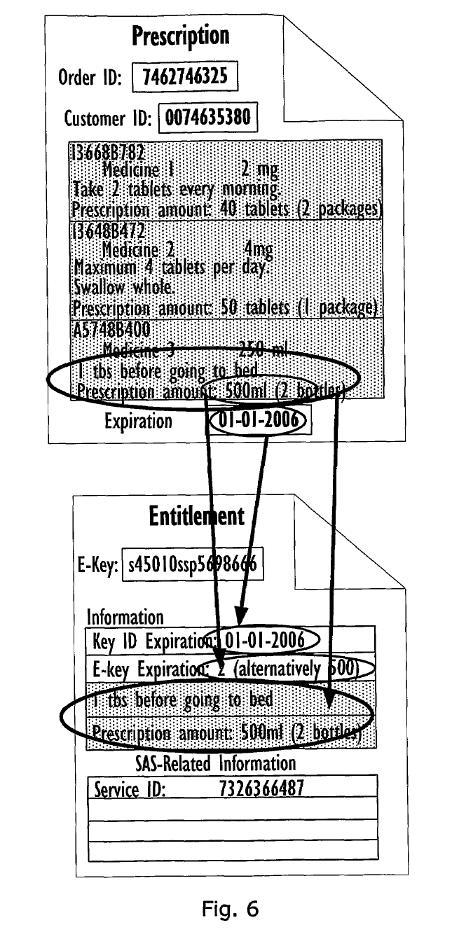

The light areas in the entitlement of FIG. 6 are SAS information and must be “filled out”. Shaded areas however are optional and may for example contain important information to be associated with the entitlement.

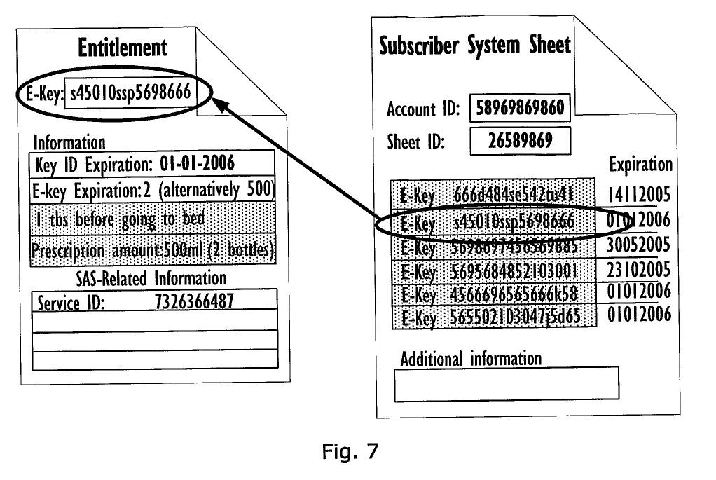

As illustrated in FIG. 7, the SMS keeps track of its own entitlement through the generated entitlement key, the E-key. To associate the E-key to a customer, the SMS associates the entitlement to an account belonging to the customer. To further structure and granulate the SMS information the Subscriber system sheets may be used, for example to separate family members' prescriptions (a mother and her children).

In order to extract information (e.g., match information) from the system the pharmacy customer usually needs to place an order. This is an electronic order entered to the SMS. The order means that the customer wants to extract his/hers E-keys to be able to see the data in plain text. The order from the customer can not be managed by the SAS since it does not recognise the customer directly. Instead, this first identification is performed by the SMS.

When the SMS has identified the customer it places an extraction order containing one or several keys to the SMS. This depends on if Subscriber sheets are used in the SMS and their granularity. If Subscriber sheets are used the granularity could be increased greatly depending the prescription format. An increase in granularity implies that fewer E-keys need to be matched for the customer to be able to find and pick out a row in the prescription.

As illustrated by the above example, by first making the prescription anonymous (with an entitlement) and later fragmenting the prescription into product specifications with a label, the information is no longer a prescription, but a fragment of information. This ensures that the legal issue is no longer an issue and personal integrity ensured.

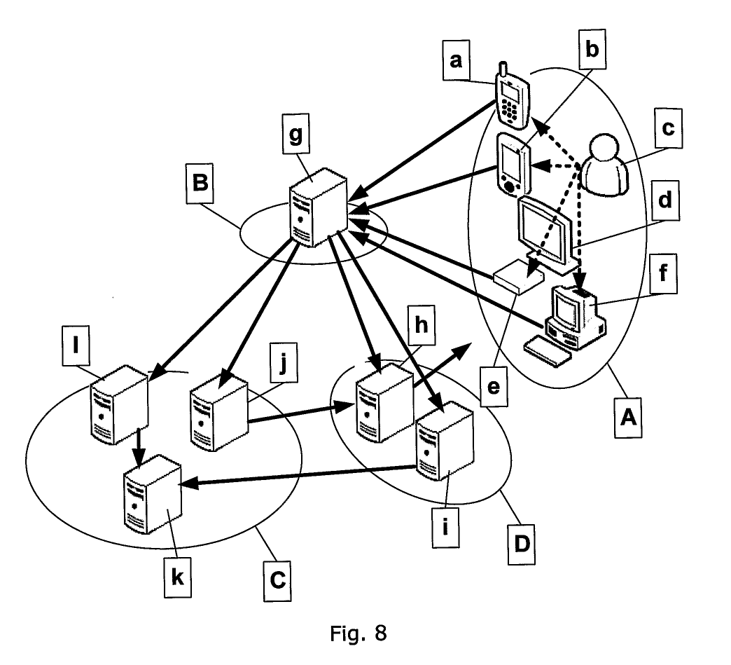

FIG. 8 illustrates a general system deployment. The exact deployment of media services (marked as l. in the figure) and products (marked as i. in the figure) may vary according to business needs and security requirements posed on the system. The references used in FIG. 8 represents the following:

A. Client Domain (SMS and SAS)

B. SMS Domain

C. SAS Domain

D. SMS or SAS Domain

a. Smart Phone

b. PDA

c. End-user

d. TV

e. Set-top box

f. Computer

g. SMS

h. Matching

i. Products

j. SAS

k. Service Packaging

l. Media Services

The figure illustrates three main domains: the Client domain (A.), the SMS domain, and the SAS domain (C.). These are well defined and communicate through well-established rules. The SMS or SAS domain (marked as D. in the figure) contain the system parts that may be placed in either the SMS domain or the SAS domain according to security and functionality requirements posed on this CAS.

The Client domain (A) holds the devices, the client hardware, running the client software needed to communicate with the Back-end. Theses devices may be any devices able to run the CAS software and display the media or the services offered and protected by the CAS. The figure illustrates some example hardware that may run the client software: a smart phone (a.), a PDA (b.), a set-top box (e.), and a computer (f.). The end-user (c.) is also part of the Client domain and may be in possession of secrets to identify himself/herself to the system via the end-device using for example PIN codes, passwords, one-time passwords, e-signatures etc.

The end-user places an order using one of the proposed end-devices to the SMS (g.). The SMS identifies the end-device and end-user and places an extraction order to the SAS (j.) as well as sending the Matching module (h.) information to match the entitlement data, which is sent by the SAS, with the personal subscriber data sent by the SMS. The SMS may also feed the Media Service (l.) or/and the Product system (i.) with information to be stored for further transmission to the clients. The Matching module in turn transmits the match information to the predetermined end-device. But before the SAS can create entitlements to give to the clients to access the media and product services the SAS needs to package (or bundle) them into service packages. This is done in the Service Packager (k.).

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An authorization system for the protection of digital content and subscriber integrity in a digital content distribution system, the authorization system comprising:
at least one subscriber management system arranged to maintain subscriber identification data; and
a subscriber authorization system arranged to maintain subscriber entitlement data separately from the subscriber identification data,
the subscriber management system being arranged to identify a subscriber upon receipt of a request by said subscriber to extract digital content, and to generate an order to the subscriber authorization system to entitle the subscriber to access to the requested digital content; and
the subscriber authorization system being arranged to, upon receipt of such an order, verify the subscribers entitlement to access to the requested digital content and if verified transmit to a system client associated with the subscriber an entitlement to access the requested digital content.

2. The authorization system according to claim 1, wherein the subscriber entitlement data is maintained by the subscriber authorization system in fragmented form.

3. The authorization system according to claim 2, wherein keys to the fragmented subscriber entitlement data are maintained by the subscriber management system.

4. The authorization system according to claim 3, wherein the order to the subscriber authorization system to entitle the subscriber to access to the requested digital content contains the keys to the fragmented subscriber entitlement data.

5. The authorization system according to claim 4, wherein the subscriber authorization system is arranged to verify the subscribers entitlement to access to the requested digital content using the keys.

6. The authorization system according to claim 1, wherein metadata associated with the subscriber identification data are maintained by the subscriber management system.

7. The authorization system according to claim 6, further comprising:
a matching module arranged to match the entitlement information to the corresponding metadata and subscriber identification data for enabling presentation to a system client associated with the subscriber of personal subscription information.

8. The authorization system according to claim 7, wherein the subscriber entitlement data is arranged to comprise medical prescription data whereby the personal subscription information comprises personal medical prescription information.

9. The authorization system according to claim 1, further comprising:
an entitlement history functionality arranged to keep track of expired entitlements for a predetermined amount of time.

10. A method for the protection of digital content and subscriber integrity in a digital content distribution system, the method comprising:
arranging at least one subscriber management system to maintain subscriber identification data; and
arranging a subscriber authorization system to maintain subscriber entitlement data separately from the subscriber identification data,
arranging the subscriber management system to identify a subscriber upon receipt of a request by said subscriber to extract digital content, and generate an order to the subscriber authorization system to entitle the subscriber to access to the requested digital content; and
arranging the subscriber authorization system to, upon receipt of such an order, verify the subscribers entitlement to access to the requested digital content and if verified transmit to a system client associated with the subscriber an entitlement to access the requested digital content.
